(19) United States
(12) Patent Application Publication
(10) Pub. No.: US 2006/0244190 A1
(43) Pub. Date: Nov. 2, 2006

(54) Pin locking method and apparatus for pin-supported workpieces

(76) Inventor: Gunter Erdmann, Medway, MA (US)

Correspondence Address: Robert K. Tendler, 65 Atlantic Avenue, Boston, MA, 02110, US

(21) Appl. No.: 11/204,478

(22) Filed: Aug. 16, 2005

Related U.S. Application Data
(60) Provisional application No. 60/675,999, filed on Apr. 29, 2005.

(51) Int. Cl. B25B 5/16

(52) U.S. Cl. 269/266

(57) ABSTRACT

Pin supported printed circuit boards are provided with torsion spring locking assemblies in which torsion springs surround the pins and are captured at one end and have free ends that are deflected, causing a tight grip onto the pins. The result is a pin locking mechanism that is inexpensive and robust due to the elongated contact of the spring with the pin that firmly locks the pin in place, with the extended spring contact protecting the pins against abrading and scoring while providing exceptional locking force.

### RELATED APPLICATIONS

This Application claims benefit of U.S. Provisional Patent Application No. 60/675,999 filed Apr. 29, 2005, entitled Apparatus to Support a Circuit Board, the contents of which are incorporated herein by reference.

### FIELD OF THE INVENTION

This invention relates to the support of work pieces and more particularly to a locking mechanism for locking pins used to support a work piece having an irregular contour.

### BACKGROUND OF THE INVENTION

As described in U.S. Pat. No. 5,984,293, there is a requirement for a universal fixture for supporting printed circuit board assemblies during stencil printing, pick-and-place processing and other printed circuit board assembly processes including the dispensing of conductive adhesives on the top surfaces of printed circuit boards. These particular operations suffer from printed circuit board flexure during manufacture. For instance, with current technologies, printed circuit boards must be maintained flat to within one one-thousandth of an inch to establish a datum plane for printed circuit boards. Not only must the lateral position of the circuit board be maintained to exacting tolerances, due to the flexure or warping of the board during processing, the boards must be robustly supported, especially for dispensing, printing and pick-and-place operations in which the components placed in these operations can on occasion press on the printed circuit board and deflect it.

This type of tolerance control during printed circuit board assembly is also critical when, for instance, one seeks to deposit an exact amount of solder paste through a stencil at precise positions over a circuit board. For single-sided boards flatness is not a problem. However, supporting a double-sided board that has been partially populated on its underside presents especially severe challenges.

Note that, in order for components to be mounted by pick-and-place machines or the like, conductive adhesive or solder paste must be positioned on a flat flip surface of the circuit board that already carries components on its underneath side. If the circuit board flexes during stenciling, the spacing between the apertures of the stencil and board will vary. This can cause the squeegeed solder paste to spread out on the board more than intended, which can cause shorts.

Moreover, instead of using a stencil, oftentimes a syringe-type adhesive injector is required. Not only must the lateral position of the syringe injector tip be controlled, but also the position of the tip of the injection needle must be precisely spaced from the top of the circuit board to provide a highly defined conductive adhesive spot. If the distance varies between the tip and the top surface of the circuit board, either an over-amount of the conductive adhesive will be deposited or the syringe-type needle will punch into the circuit board, at which point its exit orifice is occluded, blocking the release of conductive adhesive.

In the past, the support of contoured or irregular bottom sides of double-sided printed circuit boards has been accomplished through the use of an array of pins, sometimes called pogo pins, which are upwardly biased against the irregular surfaces of the circuit board caused by the underside components. Such a process is described in the aforementioned U.S. Pat. No. 5,984,293, in which once the pins are positioned by pressing the circuit board with the underside components against the pins, a translating apertured plate grabs the pins and locks the pins in place so that multiple circuit boards can be subsequently positioned on this pin array structure.

Self-conforming support systems involving an array of pins or a bed of nails are described in U.S. Pat. Nos. 6,264,187; 6,029,966; and 6,726,195. In each of these patents the locking mechanism is a translating apertured plate that grabs one side of the pins after they have been positioned by the pressing down of the circuit board on the pin array.

The problem with translating-plate locking mechanisms is that the apertures in the translating plate dig into the sides of the plastic pins, scoring them and generally rendering them unusable after a number of such operations.

One such pogo pin structure is manufactured by Production Solutions, Inc. of Poway, Calif., called the Red-E-Set board support system that involves arrays of pins carried by pin-locating bars. These pins are pneumatically actuated to contact the underside of the populated printed circuit board. Since these pins are plastic, the sliding plate locking structure digs into the pins after a number of actuations and causes failures.

Another type of irregular or conformal support system is manufactured by Airline Hydraulics Corporation of Bensalem, Pa. in the form of their Gridlock SMT support system. This system is described in U.S. Pat. No. 6,702,272, which shows a locking system involving a ball/channel arrangement, with the ball contacting the pin as it slides down the channel by gravity after the pin has reached its desired extension. To unlock the pins, a vacuum initially lifts the balls away from the pins to release them. To lock the pins, the vacuum is released and the balls fall by gravity into the hardened steel pins. To unlock the pins, the vacuum is re-established. As will be appreciated, sealing of this ball/channel structure is complicated and internal air leaks can occur if proper sealing is not maintained.

Thus such a locking system is expensive and complicated due to the number of parts and air seals necessary. Moreover, since the pins are cylindrical and the balls are round, the contact between the two is only at a point. It will be appreciated that single point locking is somewhat less robust than all-around contact would be. While the Gridlock system is said to be usable for printers, chip shooters, pick-and-place machines and dispensers used in surface mount technology (SMT) assembly, the complicated locking system with its multiple balls, channels and seals makes such printed circuit board support prohibitively expensive.

It will be appreciated that double-sided circuit boards can also be supported by magnetically actuated pins. However, magnetic locking of the pins is not easily achieved because of the relatively high magnetic fields that must be created, and some components are sensitive to magnetic fields.

Another type of supporting system for irregularly shaped articles is discussed in U.S. Pat. No. 4,200,272, which utilizes pneumatically operated clamping bladders to lock the pins, whereas U.S. Pat. Nos. 5,722,646; 4,684,113; 5,157,438; 5,820,983; and 5,819,394 describe other methods for supporting irregularly shaped articles in the manufacturing process.

Moreover, U.S. Pat. Nos. 6,252,415; 6,834,243; 5,656,943; 6,641,430; and 6,676,438 describe pin block structures for supporting work pieces for manufacture and testing.

As mentioned above, such positioning tools or supports have found usage in surface mount technology in which components are mounted on two sides of a printed circuit board. Because of the increased demands on the flatness of the printed circuit board during fabrication and population, one requires a support structure that is easily pre-configured for the underside of populated boards to be able to assure a flat topside for further printed circuit board assembly and processing.

It is noted that in order to properly maintain the planar structure of the printed circuit board, the pins need to be spaced no more than 0.75 inches apart so as to eliminate any flexure of the printed circuit board therebetween. Note also that the thickness of typical double-sided circuit boards is on the order of 0.031 to 0.62 inches.

In summary, it is known that printed circuit boards routinely flex during printed circuit board assembly, and that this flexing must be eliminated.

### SUMMARY OF INVENTION

Rather than utilizing the locking mechanisms described above in which pins are physically clamped in place utilizing either a translating apertured plate or a ball/channel assembly, and rather than utilizing magnetic actuation and locking mechanisms, in the subject invention a pin bar is provided with an upwardly projecting array of pins, each surrounded by a locking torsion spring. One leg of each spring is anchored or secured to the bar and the free leg is deflected to decrease the inside diameter of the spring creating a solid lock around the pin to lock it in place. In one embodiment a number of pin-carrying bars are mounted to a frame, with the number of bars secured to the frame creating support for printed circuit boards as large as 24″×24″.

In a setup procedure, the circuit board is placed on four equally high support pins on each corner. The circuit board may have many components of various heights, shapes and forms on the bottom side, presenting an irregular surface.

A flat plate larger than the circuit board is placed on top of the circuit board and secured in that position. The pins are now activated traveling upwards and will come in contact with the circuit board or a component of that circuit board, pushing the board with components up against the flat support plate. The force of the pins is regulated pneumatically to avoid excessive force. The pin support pins have now conformed to the bottom side of the circuit board. The pins are then locked into place by the strangling effect of the torsion springs around the pins. This is done by deflecting the free ends of the torsion springs by, for instance, 15°, with the movement of the free ends tightening the springs around respective pins. In one embodiment, the free end deflection is accomplished by a translating notched bar designed to capture the free ends of the springs in the notches and to deflect them to tighten the springs around associated pins. In one embodiment, the springs are made of steel music wire, with the torsion spring having a 0.0158 inside diameter when relaxed for pins having a 0.0157 outside diameter. Note that the relaxed inside diameter provides a sliding fit for the pins.

It will be appreciated that when the torsion spring is deflected on itself around a pin, it provides uniform pressure about the pin from all directions due to the strangling of the pin by the associated spring. As a result of the elongated and uniform contact, the locking action does not gouge or otherwise damage the pins. Moreover, the holding power of such a torsion spring is exceptional, since the frictional contact is along the entire outer surface of the pin and along the entire length of the spring. As a result, the torsion spring is captivated.

In operation, when the populated training circuit board underside contacts the pins and the pins are moved upwardly with a pressure of, for instance, 30 psi, the pins are locked into place by the strangulation provided by the deflection of the free spring end. Thus, once having provided a sample printed circuit board called a training board and having positioned it above the pin structure, having the pins moved upwardly to contact the underside of the board and its components where the pins stop, and having locked the stopped pins, the same pin array support may be used for many hundreds of operations without recalibration.

Note, the pins exert upward pressure on the board and its components. Moreover, the upward pressure of the pins, which may be regulated, cannot lift the board because during the training run it is maintained in place or captured by a heavy plate; or the plate is clamped in place to the base of the support system. Thus with the flat plate in place and clamped, when the pins are locked, the top surface of the training board will be flat.

The anaconda effect of the springs strangling the pins in place is extremely effective as can be seen by the fact that the pins in one embodiment cannot be moved by a force of 10 pounds or more per pin.

As will be appreciated, there are few moving parts to this locking mechanism, the only movement being the movement of the free ends of the springs, with the other ends of the springs being fixed or anchored to the assembly or bar carrying the pins.

Thus, rather than having translating apertured plates, magnetically actuated pin locks and ball detent apparatus for locking the pins, in the subject invention a simple, inexpensive torsion spring is used to surround and lock each pin.

The subject multi-pin structure may be used in a wide variety of printed circuit board assembly operations. Importantly, it may be used to support double-sided circuit boards to provide a flat top surface. This flatness is essential in stenciling, pick-and-place and dispensing operations.

It is noted that while boards to be stenciled or screen-printed may be warped, if properly supported by the subject locked-pin system, the weight and pressuring of the stenciling squeegee flattens the warped boards against the locked support pins during these operations.

For other board assembly operations warped boards can be straightened by a vacuum system that forces the board onto the locked pins.

Moreover, with the subject support system, one can readily control the spacing of dispensing tips from a flat double-sided board for those operations requiring the dispensing of conductive epoxies or other adhesives at precise points with controlled lateral spreads. Since the subject locked pin array system maintains with vacuum warp correction the flatness of all portions of the top surface of a circuit board to a thousandth of an inch, this permits the syringe-type injectors to be brought down to a pre-calculated spacing between the injection nozzle tip and the surface of the board without the use of complicated and expensive laser board position sensing systems.

In terms of pick-and-place machines, the flatness of the printed circuit board assisted by vacuum warp correction permits the use of a high-speed machine without regard to circuit board flex problems. Because of the flatness maintained by the subject system, the stroke needed in placing components can be accurately pre-calculated, again without laser assist.

In summary, pin supported printed circuit boards are provided with torsion spring locking assemblies in which torsion springs surround the pins and are anchored at one end and have free ends that are deflected, causing a tight grip onto the pins. The result is a pin locking mechanism that is inexpensive and robust due to the elongated contact of the spring with the pin that firmly locks the pin in place, with the extended spring contact protecting the pins against abrading and scoring while providing exceptional locking force.

### BRIEF DESCRIPTION OF THE DRAWINGS

These and other features of the subject invention will be better understood in connection with a Detailed Description, in conjunction with the Drawings, of which:

FIG. 1 is a diagrammatic illustration of the inverting of a circuit board, populated on one side such that the populated elements point downwardly;

FIG. 2 is a diagrammatic illustration of the circuit board of FIG. 1 inverted with components on the underneath side;

FIG. 3 is a diagrammatic illustration of the underside-populated printed circuit board of FIG. 2 positioned over the subject support system, in which the printed circuit board is to be positioned underneath and aligned with a stencil;

FIG. 4A is a diagrammatic illustration of the stencil of FIG. 3 aligned over the printed circuit board supported by the subject pin array;

FIG. 4B is a diagrammatic illustration of solder paste spreading under a stencil due to board flexure.

FIG. 5 is a diagrammatic illustration of patterned solder on top of the printed circuit board of FIG. 1 after having been stenciled over the board, showing the effect of overlapping areas of deposits of solder on the circuit board of FIG. 1;

FIG. 6A is a diagrammatic illustration of the use of a pick-and-place machine to place components on the top surface of the board of FIG. 5;

FIG. 6B is a diagrammatic illustration of the effect of board flexure on stroke calculation and component placement for the pick-and-place operation of FIG. 6A;

FIG. 6C is a diagrammatic illustration of the effect of the bowing of the circuit board on the leads from a component that is to be placed on the board by a pick-and-place machine, illustrating bending of the leads due to the bowing;

FIG. 7 is a diagrammatic illustration of the soldering of the picked-and-placed components to the topside of the board of FIG. 6A in a reflow solder operation;

FIG. 8 is a diagrammatic illustration of the use of an array of pins on adjacent pin bars indicating initial retracted or down pin position, also showing four fixed plate support posts;

FIG. 9 is a schematic diagram of the limiting of the pin extensions by components on the underneath side of the board as well as the board, also showing a fixed flat plate on top of the circuit board for limiting the upward motion of the circuit board caused by the upward extension of the pins in the pin array;

FIG. 10 is a diagrammatic illustration of the subject locking mechanism for the pins of FIG. 9, illustrating each of the pins being surrounded by a helical torsion spring having one end secured to the pin bar and having the opposite end free for movement, illustrating the loose fit of the spring around the pin;

FIG. 11 is a diagrammatic illustration of the translation of a notched bar to move the free ends of the springs of FIG. 10 in the direction illustrated so as to lock the pins in position by strangulation due to collapse the spring around the associated pin;

FIG. 12 is a diagrammatic illustration of the position of the pins whose extension is dictated by the underside of the board and the components thereon, with the heights locked into place by the deflection of the free ends of the torsion springs;

FIG. 13 is a sectional view of an array of pins within a pin-bar assembly, illustrating relaxed springs around associated pins, with the movement of the free ends of the pins to the right for locking;

FIG. 14 is a top view of the sliding fit of a relaxed torsion spring about an associated pin, with the direction of contraction of the torsion spring about the associated pin indicated by the arrows;

FIG. 15 is a top view of the spring and pin assembly of FIG. 14, illustrating the tightening of a spring securely about an associated pin with the movement of the free end by approximately 15° to strangle the pin preventing movement;

FIG. 16 is a cross-sectional view of the array of FIG. 13 in which the springs strangle about the associated pins; and,

FIG. 17 is a cross-sectional view of the pin bar of FIG. 16, showing the extension of the various pins as they contact the underside of the board and the associated components when the circuit board in position and clamped to the support posts at the four corners thereof, showing the position of the pins that are to be locked.

### DETAILED DESCRIPTION

What is now presented is a method for using a pin array support that is trained on a bottom side populated circuit board in which the pins extend to touch the bottom side of the board where they are then locked in place.

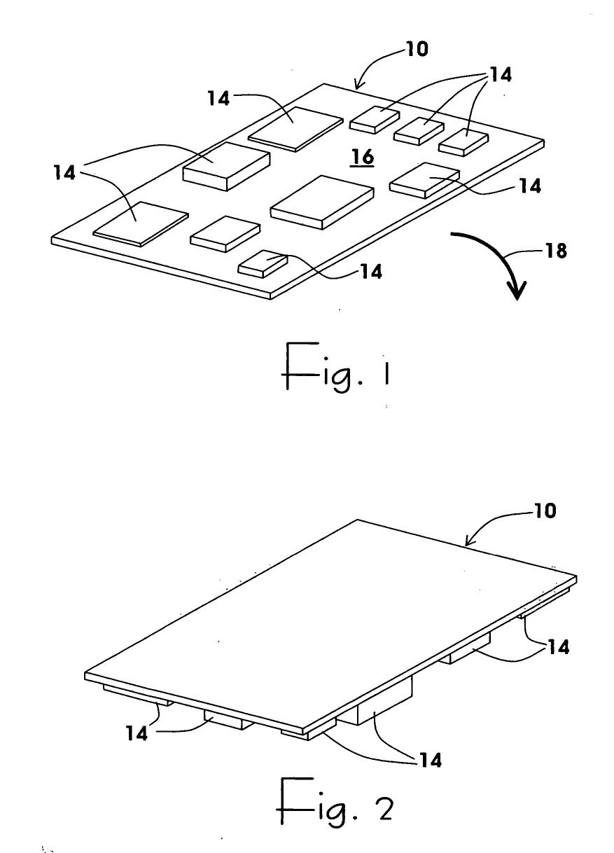

Referring now to FIG. 1, what is illustrated is a training board 10 having a number of components 14 populated on the topside 16 of the printed circuit board. Upon population of the components on top of the to-be double-sided printed circuit training board, it is inverted or flipped over as illustrated by arrow 18 so as to achieve the orientation illustrated in FIG. 2 with components 14 pointed in a downward direction. The result is an irregular or contoured underside. It will be appreciated that being able to support such circuit board that is bottom side populated to provide a flat top surface requires a support structure that can be configured to accommodate and support the various components on the underneath side of the circuit board as well as the board itself.

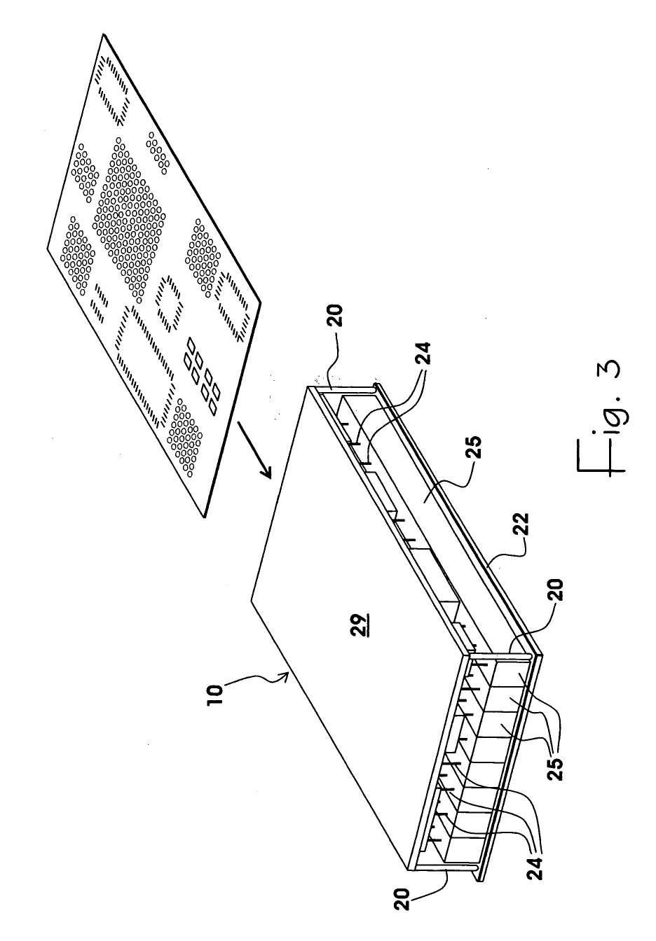

Referring to FIG. 3, training board 10 is supported at its corners by four equal height corner supports or posts 20 affixed to a base or support 22 having pins 24 extending from longitudinally running pin bars 25 to support the array of pins, with the circuit board positioned above the pin bars at its four corners. A flat plate is placed on top of the circuit board and fastened so the circuit board cannot move upwardly. This is done in one embodiment by a weighted plate and in another embodiment by clamping the plate to the support carrying the pin bars.

In an operation to be described, the pins that are initially retracted so as to present a flat surface when mounting the training board are extended to touch the underside of the training board, with the board being restrained from upward movement caused by the extending pins due to the plate on top. Once the pins touch the underside of the board and its components, they force the board up against the plate. Thereafter the pins are locked in place by the subject torsion spring locking system. Once locked, the flat plate is removed and the boards to be processed are supported on the locked pins, with the support guaranteeing a flat top surface for the rest of the boards in the run.

Once having the pin array trained to a particular board, there are a number of board processing operations that benefit from the maintenance of a flat top surface.

In one board-processing operation involving stenciling, one deposits solder paste through a fine-pitch stencil in which inter-aperture spacings are often no more than 0.006 inches. A stencil 26 is, as usual, supported in tension in a rigid frame and has apertures 28 therethrough. The flat stencil is then placed on top of surface 29 of printed circuit board 10. Note that it is the function of the subject support system that the top surface is maintained flat for this and all other operations.

In a follow-on procedure, solder is squeegeed over stencil 26 and through its apertures, with the squeegee exerting downward pressure. This downward pressure flattens any upwardly bowed boards onto the locked pins. This establishes a flat top board surface onto which the flat stencil is in contact across the entire top surface. The result is that solder paste is printed onto the circuit board through a stencil that is in intimate contact with the board top surface. Note that if the board were warped downwardly, this would cause a gap between the bottom of the stencil and the top of the board such that an aperture 28 is spaced from top surface 29 of circuit board 10. This can cause a solder spread that can result in shorting, especially for fine pitch patterns.

As will be appreciated, with modem circuit boards, the pitch for the patterned solder for some of the components is so fine that any error in the formation of a fine-pitch solder pattern can cause shorting and board failure.

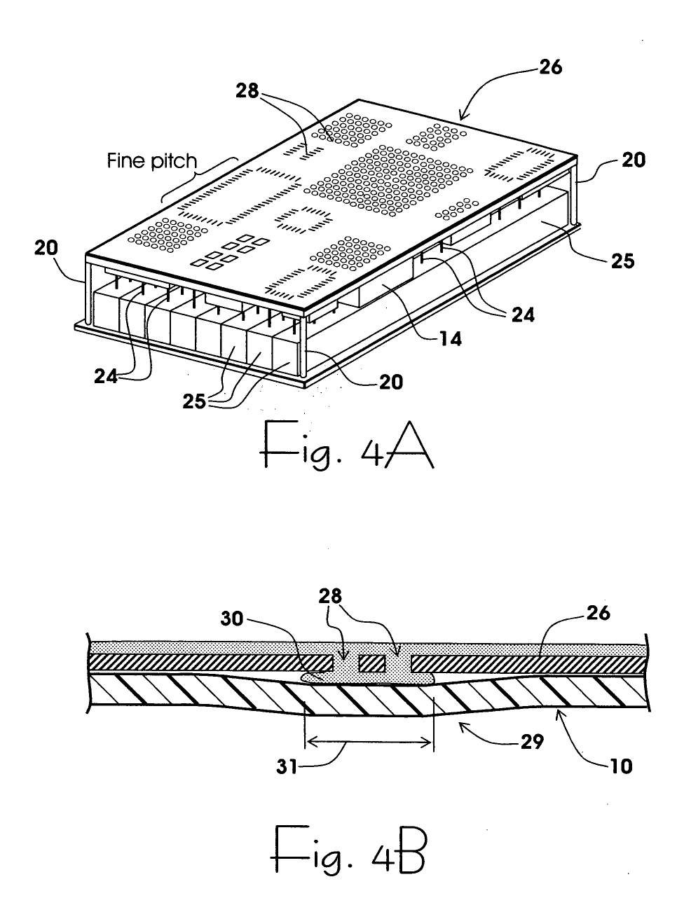

As illustrated in FIG. 4A, with stencil 26 pre-stretched, in place and aligned, and with the circuit board appropriately supported, apertures 28 in stencil 26 are in intimate contact with the top surface of the circuit board so as to assure proper solder deposition. However, as shown in FIG. 4B, if the board is not properly supported such that its top surface is not flat, then a downwardly warped board portion 29 is spaced from apertures 28 in stencil 26. As a result, it can be seen that printed solder paste 30 extends laterally over board 10 as illustrated at 31. One problem with the solder paste spread is shorting. Another problem is the mess caused by the excess solder paste on the underneath side of the stencil that can get over subsequent circuit boards.

As illustrated in FIG. 5, for a warped board not supported by the subject system, solder has been squeegeed over the stencil and the stencil has been removed, leaving printed solder paste 30 on the top surface 29 of board 10. However, at regions 31, shorted solder regions can exist if the board was not supported properly to provide a planar top surface underneath the flat stencil.

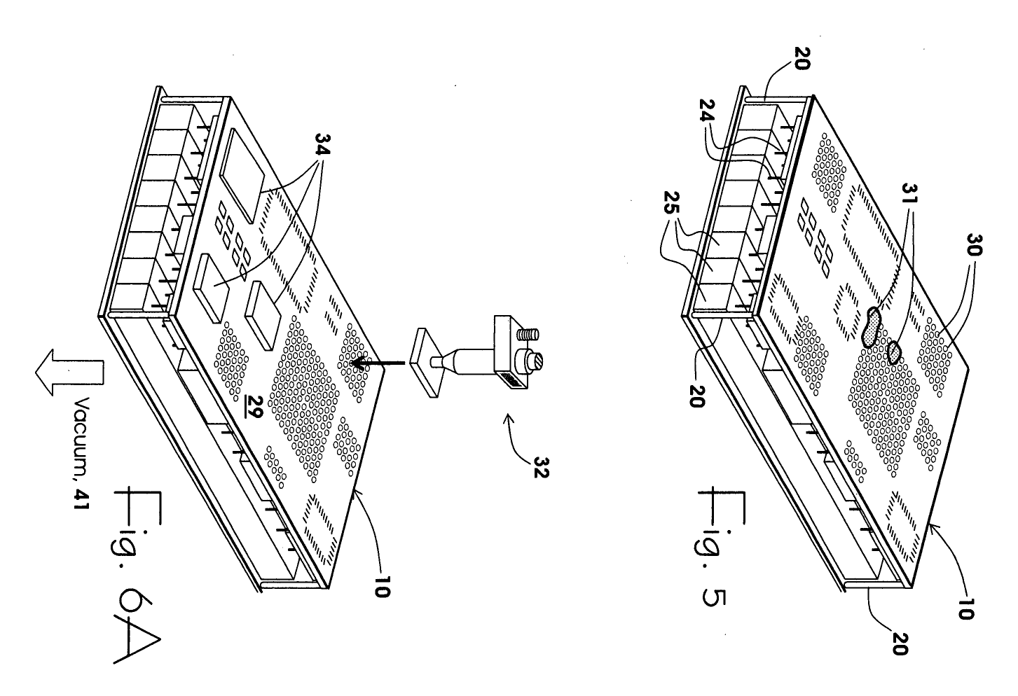

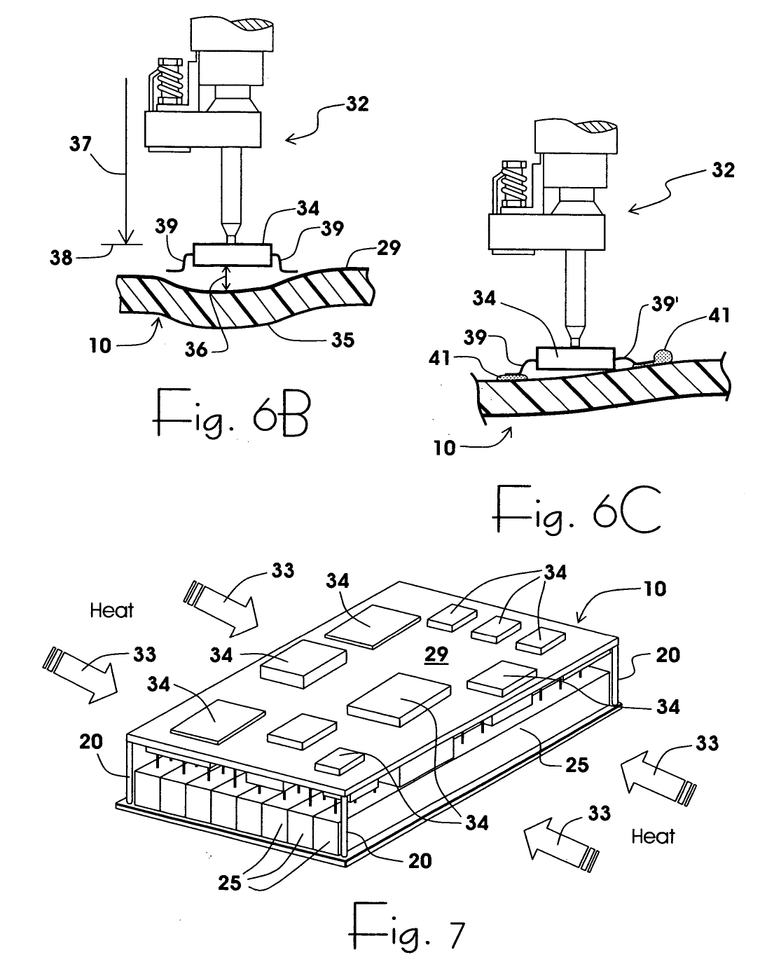

As illustrated in FIG. 6A, in another board fabrication operation a pick-and-place machine 32 is used to populate top surface 29 of board 10 with components 34 that are placed on patterned solder or other conductive adhesive points such that when, in FIG. 7, board 10 is removed and subjected to solder-melting temperatures in a reflow solder process as indicated by arrows 33, the components on the top surface 29 of board 10 are bonded to the conductive patterns on the top surface of the board.

Referring to FIG. 6B, board 10 is shown warped or flexed at 35 such that component 34 is spaced from the top surface of board 10 as illustrated at 36. This is caused by the component having been positioned from the originally calculated stroke 37. The stroke describes the downward movement of the pick-and-place head, taking into account the thickness of the particular component. Thus as shown at 38, the head of the pick-and-place tool is stopped at a position calculated assuming the top surface of the circuit board is flat. Note that legs 39 do not make contact with the top surface 29 of board 10.

As shown in FIG. 6C, if board 10 is bowed or warped upwardly, a lead 39′ from component 34 may be bent, displaced or at least mispositioned when head 32 is brought down. If lead 39′ exerts undue lateral pressure on solder paste 41, since it is soft, the paste may smudge or spread out to adjacent solder pads where shorting occurs. This can be a severe problem when spacing between solder pads is on the order of 6 mils.

Referring back to FIG. 6A, in an optional embodiment, to take care of the warped board problem, a vacuum is provided to suck the board down on the locked pins to provide a flat pick-and-place surface. This eliminates the problem of having to provide laser stroke feedback to adjust the stroke for non-flat boards.

Thus it is extremely important that the double-sided board be appropriately supported by easily locked pins to maintain an ascertainable flat top surface to assure a proper pick-and-place operation.

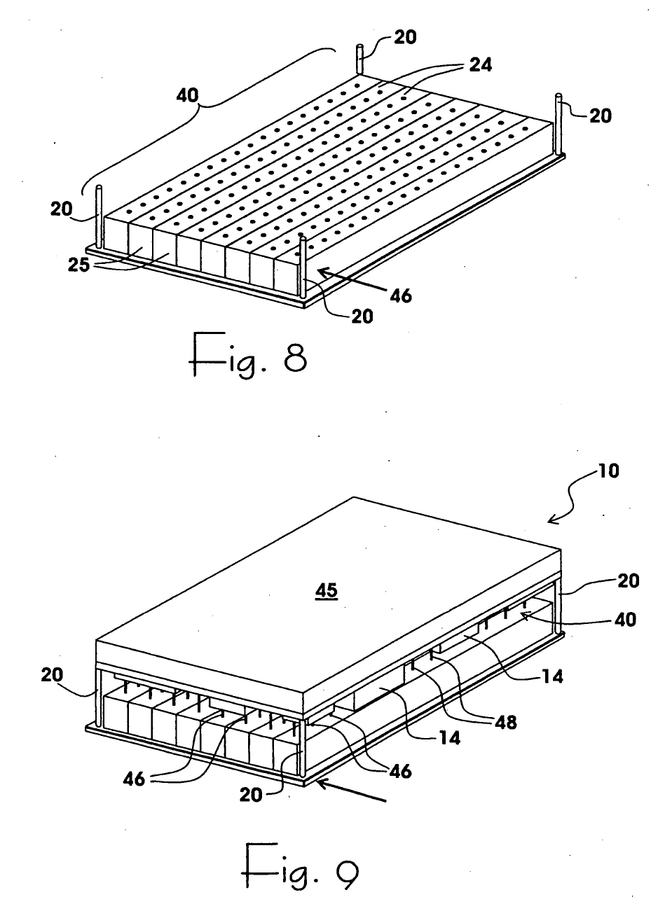

How the top portion of the boards of FIGS. 1 through 6 is maintained flat is shown in FIG. 8 to be accomplished by the subject pogo pin or bed-of-nails pin array 40 that includes a number of side-by-side pin bars 25 in one embodiment. The bars carry a number of pins 24, shown in their fully retracted positions to permit positioning of an underside populated training board on top, where the training board is supported by the equal height fixed corner posts 20.

As illustrated in FIG. 9, training board 10 is placed over the pin array and is supported over the array by posts 20. Note, initially the pins retracted or down. A flat plate 45 is then placed on top of the circuit board and is clamped in place to prevent upward movement of board 10 when the pins are extended. As an alternative to clamping, plate 45 can be made of heavy material or a weight can be placed on top of the plate. However, clamping is preferred due to the combined upward pressure provided by the pneumatic extension of the pins which would require the use of excessive and unwieldy weights. In any event the plate and board are clamped down onto corner posts 20 above on pin array 40 so that the height of the board above the pin array is fixed.

After the board is clamped into position, the pins are extended in one embodiment by the application of air pressure. As a result, various of the pins, here illustrated at 46 and 48, are limited in their upward extension by the clamped underside of the board and its components 14.

Thus, the pins come to rest on the undersides of all of the components or on bare board, with the entire training board 10 being supported on the corner posts and the pins with its topside completely flat. This is because in the training phase the board was in contact with the flat underside of plate 45.

The pins in one embodiment are spaced no more than 0.625 inches apart to meet the planar requirement for the top surface of the circuit board.

Once the pins are extended up to conform to the irregular contour of the underside of the circuit board, the pins are to be locked in place so that the pin array support can be used again and again for like-configured double-sided circuit boards.

### Pin Locking

The locking problem that is not well enough addressed in the past is how to lock the pins in position after they have been extended.

Referring to FIGS. 10 and 11, it can be seen that each of the pins 50 is surrounded with a torsion spring 52 that has one anchored end 54 secured to the bar from which the pin extends. A free end 58 protrudes from the bottom of the spring. This end can be deflected clockwise so that as illustrated in FIG. 11 the spring contracts as illustrated at 76 about its associated pin to strangle it and hold it in place. The flexing of end 58 by approximately 15° causes the spring to contract around the pin along the extended length of the spring. It is the elongated contact of the spring around the pin at all points about the periphery of the pin that causes extremely secure locking of the pin in place when the free ends are deflected as illustrated. Not only is there continuous and contiguous contact by the spring with the pin, as opposed to point contact or aperture edge contact as in the past, the length of frictional contact with the pin by the contracted spring provides an extended contact with the spring to securely lock the pin in position.

This is quite different from previous locking mechanisms in which a ball contacts the pin at one point or in which the side of an aperture of a translating plate presses against the side of a pin. The subject system is also much more robust than magnetic locking systems. It is noted that magnetic locking mechanisms are prone to failure due to the inability to maintain the high level of magnetism necessary to provide a secure lock. Moreover, high magnetic fields can damage some components.

As a result, the locking of the pins by torsion springs forms an economical, extremely robust locking system.

In order to deflect the spring ends, a translatable member 70 is provided that in one embodiment has notches 72 that cooperate with free ends 58 of springs 52 to move the free ends upon translation of the notched member in the direction of arrow 60.

This simple mechanism for tightening the springs around associated pins is illustrated by the tightened springs 75 along an extended frictional contact zone 76. The tightening or pin strangulation requires only the translation of a member with appropriately configured notches or apertures to catch and hold the free ends of the springs. Thus the pins are easily and securely locked into place as illustrated at 50′ at the appropriate extensions.

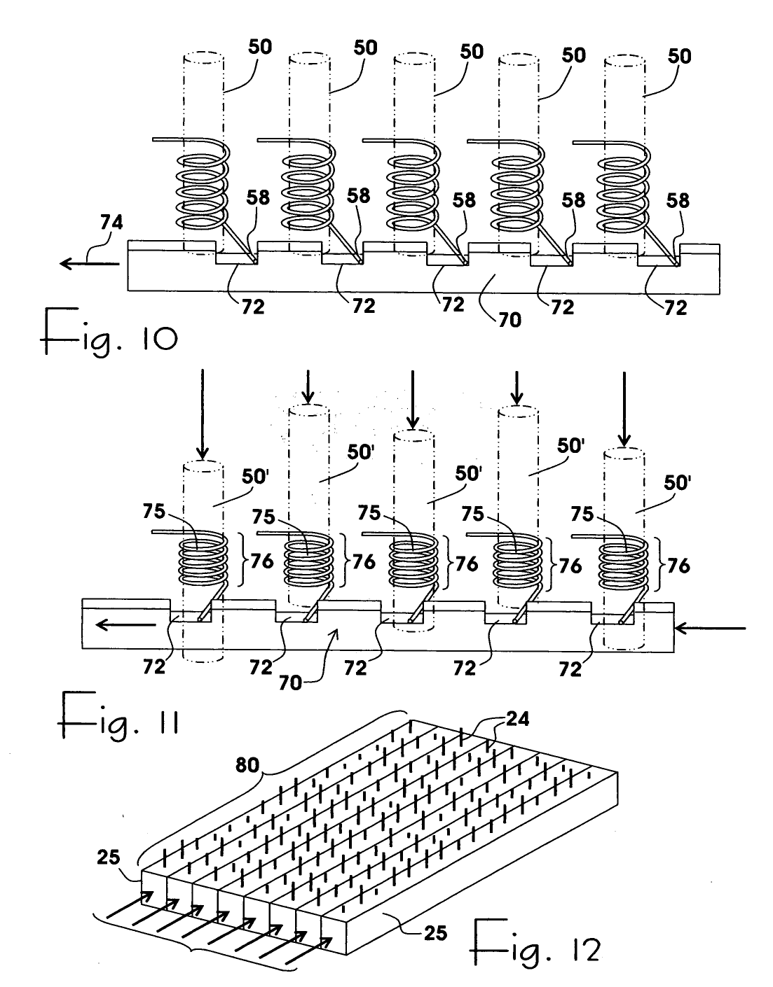

As illustrated in FIG. 12, an exemplary pin extension pattern 80 is illustrated in which pins 24 from pin bars 25 are locked to appropriate heights or extensions by operation of the subject locking mechanism. Here the member 70 may be translated by air pressure or the translatable member may be mechanically manipulated.

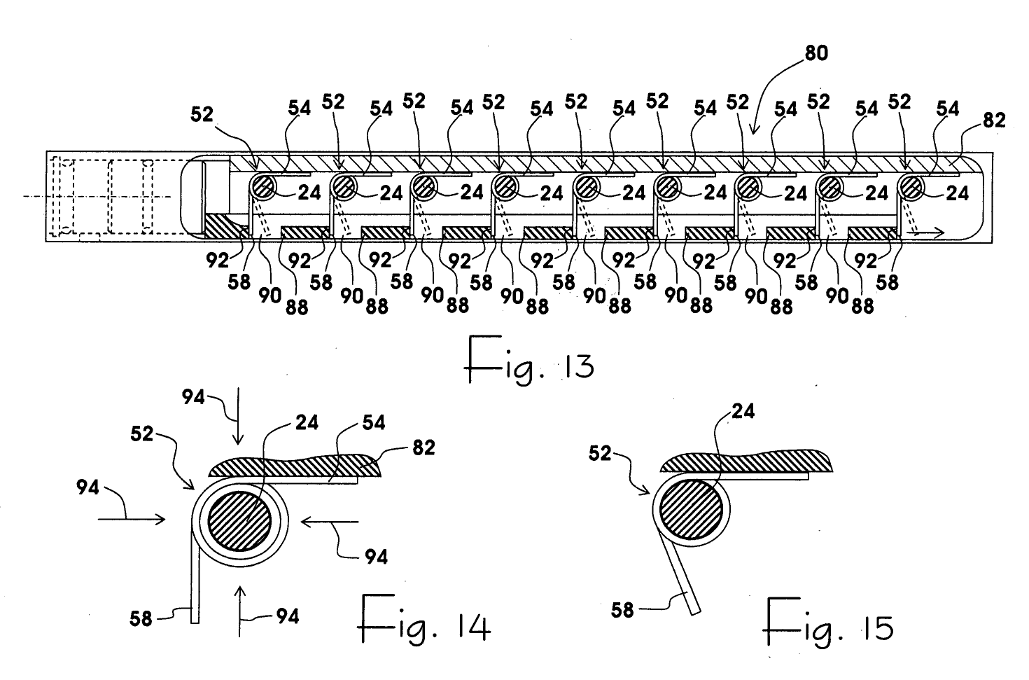

More particularly and referring now to FIG. 13, in one embodiment each of pins 24 is located in a barlike subassembly or pin bar 25 that includes a longitudinally running wall 82, with ends 54 of pins 24 secured against movement by the wall.

Referring to FIG. 14, spring 52 is shown in its open or relaxed condition prior to deflection of end 58 counterclockwise to the right. Here it can be seen that end 54 is secured against movement by wall 82.

As illustrated by arrows 94, with deflection of end 58 to the right as illustrated at FIG. 15, the spring compresses around, contracts around or strangles pin 24 to prevent pin movement.

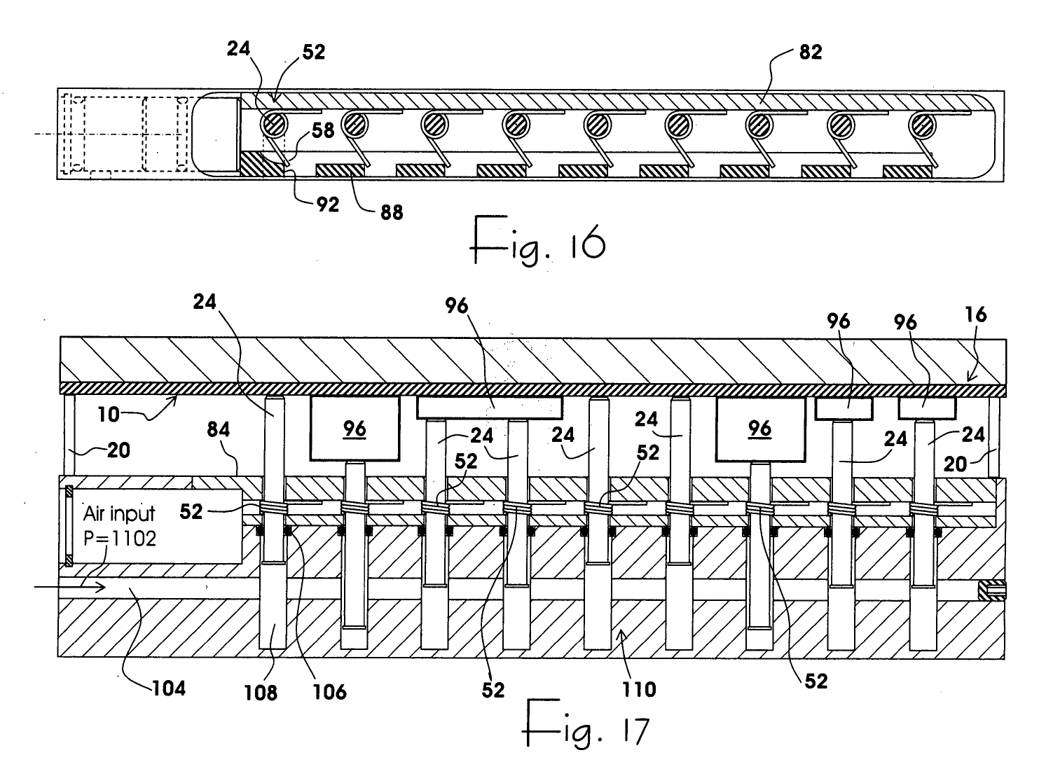

Referring to FIGS. 16 and 17, each of the pins extends through a top plate 84 of the pin bar through associated apertures 86, with a translatable member 88 having notches 90 to provide walls 92 that co-act with the free ends 58 of springs 52.

The result, as illustrated in FIG. 16, is that springs 52 tightly engage associated pins 24, with ends 58 having been moved as illustrated by notch wall 92 of translatable member 88. Here in one embodiment air pressure introduced at fitting 95 acts on piston 96 to translate member 88 to the right a predetermined distance. This distance is that which provides the optimal deflection of the free ends of the springs.

The net result as illustrated in FIG. 17 is that pins 24 are locked to the positions shown against circuit board 10 and components here illustrated at 96 that depend down from the underneath side of circuit board 10.

When the extended pins 24 are locked in place by springs 52, their positions are maintained from board to board. In one embodiment, air pressure 102 is introduced into pipe 104 to bias pins 24 when not locked up through apertures 86 in plate 84, with seals 106 used about the base of pins 24 to seal the pins into associated channels 108 in a subassembly block 110.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. Apparatus for securing the pins in a pin array printed circuit board support system in which pins are positioned against the underneath side of an underside populated circuit board, with the pin array extensions supporting the circuit board, comprising:
a torsion spring surrounding each of said pins, said torsion spring having one leg fixedly secured and having the other leg thereof free and including a free end; and,
an actuator for deflecting the free ends of said springs so as to tighten about and strangle each of said pins against movement upon deflection of said free ends, whereby deflection of the free ends of the springs provides secure locking of said pins against movement, thus to provide a stable support for said printed circuit board regardless of its uneven underside;

2. The apparatus of claim 1, and further including a bar for supporting said pins, said bar having top apertures through which said pins extend such that said pins can translate and slide through said apertures.

3. The apparatus of claim 2, wherein said actuator includes a notched member mounted for translation in said pin-carrying bar, each of said notches cooperating with a free end of a spring, translation of said bar deflecting the free ends of associated springs due to the action of the associated notch with a free end.

4. The apparatus of claim 1, wherein said torsion springs include music wire piano springs.

5. The apparatus of claim 1, and further including a multiplicity of said bars mounted side by side so as to form a laterally extending pin array.

6. The apparatus of claim 5, wherein said bars are mounted in spaced adjacency one to the other.

7. The apparatus of claim 5, wherein said bars are contiguous one to the other.

8. The apparatus of claim 5, and further including a fixture, means for mounting said bars to said fixture and wherein said fixture includes corner posts extending therefrom in a direction perpendicular to the plane of the top surfaces of said bars for the support of a printed circuit board above said pin array.

9. The apparatus of claim 8, wherein said corner posts are of equal height.

10. The apparatus of claim 1, and further including a pneumatic actuator for forcing said pins in an upward direction through the apertures in said bar.

11. A method for locking pins in a pin array printed circuit board support fixture, comprising the steps of:
surrounding each of the pins in the pin array with a spring in the form of a coil;
securing one leg of each of the springs against movement;
deflecting the free end of the other leg of each of said pins in a direction so as to collapse each of the springs around an associated pin with sufficient tightness to lock the associated pin in place.

12. The method of claim 11, wherein the spring is a torsion spring.

13. The method of claim 11, wherein deflection of the free ends of the springs causes the springs to tighten around the pins by contacting the pin surfaces on all sides, thereby to provide a robust pin locking system.

14. The method of claim 11, wherein deflection of the free ends of the springs creates frictional contact between associated pins and their springs along the entire length of the spring coil.

15. The method of claim 11, and further including the step of providing deflection of the free ends of the pins by a translatable member having a pin end-engaging feature at the free end of each spring.

16. The method of claim 15, wherein the pin end-engaging feature is a notch.

17. A lockable pin array printed circuit board support, comprising:
a number of side-by-side co-located bars, each of said bars having apertures to permit the translation of pins therethrough;
an array of pins mounted through associated apertures so as to be extensible through said apertures;
pneumatic means coupled to said bars for urging said pins in an upward direction through associated apertures;
pin locks for each of said pins including a torsion spring for each pin, each torsion spring having one leg thereof secured against motion by the associated bar and having a free end; and,
an actuator for deflecting the free ends of said springs so as to tighten and collapse the associated springs around said pins to lock the pins in place.

18. The support of claim 17, and further including a fixture for mounting said bars in horizontal adjacency, and printed circuit board-supporting corner posts extending upwardly from said fixture.

19. The support of claim 17, wherein each of said bars includes one of said actuators, each of said actuators including a translatable member having a number of free pin end-engaging structures such that by translating said member all of the free ends of the springs in a bar are deflected to tighten associated springs around associated pins.

20. The support of claim 19, wherein said translatable members are mounted for translation within an associated bar.

21. A method for locking the pins of a pin array support system in place, comprising the steps of:
surrounding each of the pins with a torsion spring;
anchoring one end of the torsion spring; and,
deflecting the free end of the torsion spring to collapse the spring about the pin to strangle the pin and lock it in position, whereby the locking contact of the spring is extended at all points on the circumference of the pin contacted by the spring.

22. The method of claim 21, wherein the torsion spring includes a music wire.

23. The method of claim 21, wherein the deflection of the spring to effectuate collapse and strangulation of the pins is 15°.

24. The method of claim 21, wherein the spring when relaxed forms a sliding fit over the associated pin.

25. The method of claim 21, wherein each of the pins of the array is captured in a longitudinally extending pin bar and wherein the pins are arrayed by arraying the pin bars in side-by-side fashion.

26. A support for irregularly shaped articles, comprising:
an array of pins;
a pin-carrying structure for supporting the pins such that the pins can be extended from the structure in an upward direction;
biasing means for extending the pins in an upward direction;
a torsion spring around each pin and slidedly engaging the associated pin when said spring is relaxed; and,
a mechanical actuator for actuating the free ends of the torsion springs so as to deflect said free ends so as to collapse said free ends around the associated pins, thereby to lock the pins in position.

27. The support of claim 26, wherein said support structure includes a number of longitudinally extending pin bars from which said pins protrude, said pin bars arrayed parallel to each other to form said support.

28. The support of claim 21, including upstanding corner supports positioned to support a training board above said pin array structure, and further including a plate adapted to contact the top surface of an underside populated training board so as to maintain the top surface of said training board against upward movement when said pins are extended to contact the underside of said board and the components thereof.

29. The support of claim 21, and further including gas pressure for extending said pins and at least one channel communicating with said pins for admitting said gas pressure so as to co-act with the bottoms of said pins.
